(19) United States
(12) Patent Application Publication
(10) Pub. No.: US 2001/0033527 A1
(43) Pub. Date: Oct. 25, 2001

(54) Self cleaning inline mixer

(76) Inventor: Robert L. Smith, Middleboro, MA (US)

Correspondence Address: CESARI AND MCKENNA, LLP, 88 BLACK FALCON AVENUE, BOSTON, MA, 02210, US

(21) Appl. No.: 09/772,175

(22) Filed: Jan. 29, 2001

Related U.S. Application Data
(60) Provisional application No. 60/178,625, filed on Jan. 28, 2000.

(51) Int. Cl. B01F 5/06

(52) U.S. Cl. 366/337

(57) ABSTRACT

An in-line mixer is disclosed that provides uniform blending of chemicals, polymers or gases in serous fluids, serous solids or water waste streams with components that are either fibrous, gummy, tacky or larger than normal substances that would plug up inline mixers that now exist. The materials are mixed while in transit and the design provides for self cleaning where material do not accumulate. The in-line mixer has inclined plates set apart, and the plates extend past the center axis of the pipe. One or more injection ports are positioned just past the plates where the turbulence allows mixing but preventing material accumulation.

### RELATED APPLICATIONS

The present invention claims priority from the U.S. provisional application of the same title and inventorship, filed Jan. 28, 2000, Ser. No. 60/178,625, and which provisional application is hereby incorporated by reference herein.

### FIELD OF THE INVENTION

The invention relates generally to devices that mix fluids or solids homogeneously while in transit, also referred to herein as “in-line.”. More particularly, the invention relates to such mixers that process waste streams with solid debris without plugging or clogging.

### BACKGROUND INFORMATION

In industry there is a need to blend non-uniform slurries of chemicals, polymers, gases or solids in streams including components that are fibrous, gummy, tacky or of larger than normal substances. Known systems utilize separate stationary mechanically driven propeller type mixers to blend the mixture. The mix is then transferred to a next processing station. However, incomplete or non-uniform mixing is often a problem with this type system causing inaccurate measurement of fluid content parameters. Other known devices that blend mixtures in transit cannot be used in streams containing fibrous, gummy, tacky or of larger than normal aggregates due to clogging. Other known in-line mixers employ static mixing using plates set perpendicular to the flow or a honeycomb construction, but they are limited to relatively uniform and unadulterated fluids.

Due to the limitations of in-line mixers, at present, virtually all mixing of these non-uniform slurries occurs in stationary tanks with propeller type mixers where in most cases homogeneous blending of the chemicals, polymers or gases are not consistent. This inconsistent blending can be the source of incomplete or inefficient separation, precipitation or oxidation of the contaminants in the fluid.

### SUMMARY OF THE INVENTION

This invention is designed to address the above limitations and problems. The present invention includes a conduit or a pipe carrying the flowing materials and fluid to be mixed. The invention includes plates that are set at angels to the flow directions. The physical layout of the fixed internal mixing plates effects interacting flow patterns and anomalies thereby generating forced blending of the flowing non-uniform slurries of fluid, gaseous components and/or solids. Turbulence occurs primarily behind each plate creating a zone of mixing and blending. The turbulence creates a blending force that occurs in a short distance just after the plate. At the same time and at the same location behind the plate, the turbulence creates a purging action that keeps debris from building up behind the plates. The result is a mixing, non-clogging and self cleaning in-line mixing device. The present invention can be advantageously used in pressurized flows and in a suction (vacuum) configuration. In fact intrinsic design parameters of a preferred embodiment can provides higher performance when the inventive device is used in a suction arrangement.

In a preferred embodiment, the conduit may be of virtually any cross section shape, for example round (a pipe), oval, square, oblong, ellipse, and other such shapes. Moreover, the conduit may not be of uniform cross section along its length.

The present invention can be advantageously employed in applications (such as high flow conditions) requiring an inline-mixing device having multiple injection ports. The positioning of the ports with respect to the plates are arranged to create turbulence at the point of injection. In a preferred embodiment, the injection ports are fed by a manifold for equal distribution of additive at each point of injection. Multiple injection ports provide a means to induce a more homogenous and controlled feed of the additives to be blended into the flow stream. This increases the effectiveness of the inline mixer while in many instances reducing the measure of additive needed for a particular desired effect. The inventive device provides for a more homogeneous and controllable blending which results in a better treatment (encapsulation) of contaminates in a waste stream while using smaller quantities of chemicals, polymers or other additives. The present invention is more easily re-used due to the self cleaning inherent design.

### BRIEF DESCRIPTION OF THE DRAWINGS

The invention description below refers to the accompanying drawings, of which:

FIGS. 1A and 1B are front and side views of a one plate in-line mixing pipe.

FIG. 2 is a side view of a multiple plate in-line mixer.

FIG. 3 is the drawing of FIG. 2 showing injector ports.

FIG. 4 is a side view of another example of an in-line mixer.

FIG. 5 is a view of FIG. 4 with five plates.

FIG. 6 is a view of a completed in-line mixer of FIG. 5 showing injection ports.

FIG. 7 is a side view of a one plated mixer with a more inclined plate. And,

FIG. 8 is a side view of FIG. 7 with more plates.

### DETAILED DESCRIPTION OF AN ILLUSTRATIVE EMBODIMENT

### EXAMPLE 1

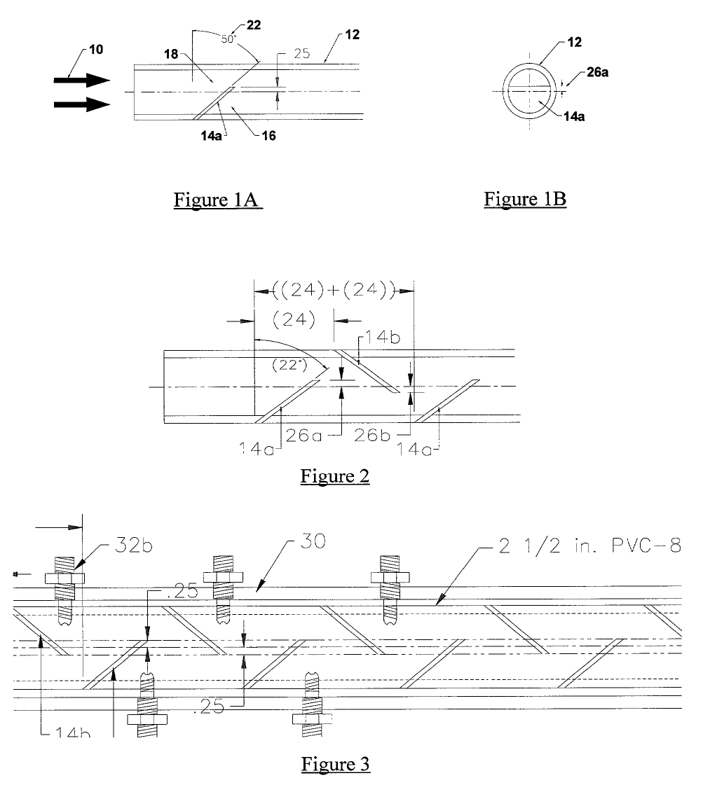

One application of the present invention is shown in FIG. 1. A fifty gallon-per-minute (GPM) flow 10 of waste water, containing suspended solids such as fats, oils, lint and other components, is flowing through an in-line 2½″ internal diameter pipe mixer 12 made in accordance with the present invention. The 50 GPM flow rate translates to a flow velocity of 8.8 feet per second at the occluded plate portion 20 of the mixer. The flow rate is derived mathematically wherein fifty GPM equals 0.1117 cubic feet per second. The occlusion of the 2½″ mixer is 0.0127 square feet, and 0.117 divided by 0.0127 equals 8.8 feet per second. Empirical testing has shown that a flwo rate above 8.5 feet per second will provide satisfactory mixing results.

Constructing an inline mixer for these conditions involves understanding the fluid dynamics with respect to the expected results. The pipe material may be PVC, ABS, and Stainless Steel and other materials known in the art. The plate 14a in the pipe disrupts the normal orderly flow of the liquid waste stream 10. The plate causes both a directional change of flow as well as a flow restriction or resistance. This restriction translates into a pressure build up which, if too great impedes the intended flow, and, if too low, does not blend the waste flow. As the fluid 10 passes the plate 14a and enters the following unrestricted area 16, a pressure drop occurs between point 18 and point 16. If the plates are mounted perpendicular (not shown) to the pipe walls and the fluid flow the area behind the plates where the pressure drop occurs will tend to accumulate components that are fibrous, gummy and tacky or of sufficient size to resist flow. To compensate for this accumulation the plates are set at an inclination 22. This inclination 22 is selected with regard to the composition of the materials in the flow stream.

With reference to FIG. 2, plates 14b and 14c have been added downstream from plate 14a. The distance 24 between plates is a design parameter that depends on the specific flow material and specifications. For example, if the plates are too close the flow resistance will be too high, and if too far apart the low pressure void areas just beyond (down stream) each plate will remain static and allow components to accumulate. For a 50 GPM flow a 2½″ diameter pipe is provided for the mixer body. The first plate is positioned at an angle 22 of fifty degrees from the perpendicular.

The second plate 14b is positioned 2¾″ downstream from the first plate also at an angle of fifty degrees from the perpendicular on the opposite side of the pipe.

Looking down the center axis of the pipe, the two plates overlap the center axis of the pipe 26a and 26b by ¼″ each or by a total of ½″ at the center line. The third plate 14c is then inserted at an angle of 50 degrees from the perpendicular on the same side of the pipe as the first plate 14a down stream from the second plate. Plates 14a and 14c are 5½″ apart.

Succeeding plates are installed in the same manner for the length of the mixing pipe.

With respect to FIG. 3, for a wastewater application, the inline mixer 30 is also used as an injection device. Injection ports 32a, 32b, 32c, etc are positioned behind the plates 14a, 14b, 14c in unrestricted area (FIG. 16) where a pressure drop occurs. Multiple injection ports may be arranged and fed by a manifold (not shown)for equal distribution of additive at successive points along the flow stream to provide a more homogenous and controlled feed to the additives to be blended.

The manifold 30 design achieves a more homogeneous and controllable blending which results in a better encapsulation of contaminates in a waste stream while using smaller quantities of chemicals, polymers and/or other additives.

### EXAMPLE 2

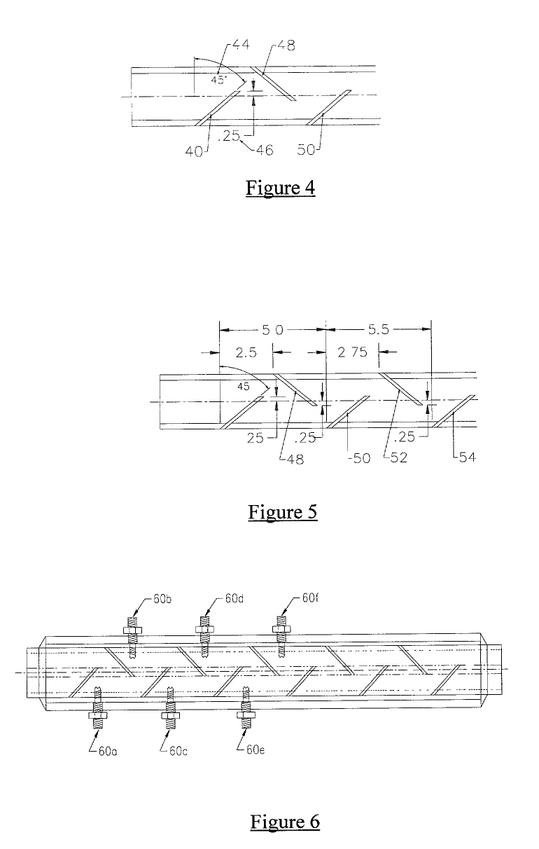

The present invention can be used to advantage in the food industry to blend juices such as, for example, mixes of cranberry and apple juices. This example uses a suction (vacuum) configuration to draw the fluid through the in-line mixing pipe. Material specifications for this application must meet FDA approval such as an in-line mixing pipe made from stainless steel. As shown in FIG. 4, a 2½″ diameter stainless pipe for the mixer body is employed for a 30-40 GPM flow rate. The first plate 40 is positioned at an angle 44 of forty-five degrees from the perpendicular. The length of the plate extends beyond the center axis of the pipe by ¼″.

A second plate 48 is then inserted at an angle of 45 degrees from the perpendicular on the opposite side of the pipe and extends beyond the center axis of the pipe by ¼″. The two plates are 2½″ apart. The third plate 50 is then inserted at an angle of 45 degrees from the perpendicular on the same side of the pipe as the first plate in a like fashion. Plates 40 and 50 are five inches apart.

As shown in FIG. 5, the fourth plate 52 is positioned 2¾″ from plate 50, and a fifth plate 54 is positioned 2¾″ from plate 52. on the opposite side. These plates are on alternates sides and at 45 degrees from vertical as shown in FIG. 5. These plates also extend beyond the center axis of the pipe by ¼″. Plates 50 and 54 are 5½″ apart.

Succeeding plates are installed in the same manner as plates 52 and 54 for the length of the mixing pipe.

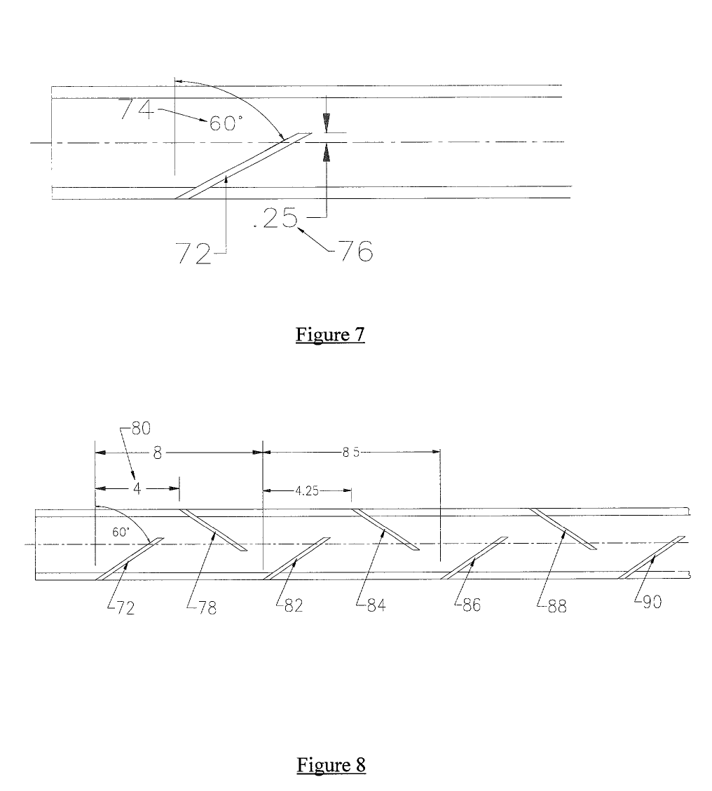

FIG. 6 shows the in-line mixer for juices complete with injection ports 60a, 60b, 60c, 60d, 60e, and 60f distributed along the pipe. As discussed above these injection ports are located just behind the plates where the pressure drop occurs. A manifold (not shown) may envelop the pipe and provide a means for injecting equal amounts into the flow stream in the pipe.

In the present invention, six injector ports equally injecting apple juice into a cranberry juice flow provides a homogenous and controlled juice blend. As discussed above, portions of the fluid flow are redirected behind the plates, mix in the space behind each plate, and then blend with the ongoing process flow. In this example, total injected flow of 10 GPM apple juice plus an initial flow of 30 GPM cranberry juice yields a total flow of 40 GPM of mixed juice. A flow rate of 40 GPM in a 2½ inch diameter mixing chamber constructed in the above manner translates to a flow velocity of 9.0 feet per second in the device.

### EXAMPLE 3

In the refining industry there is a need to blend crushed ore fines with a mixture of flour, lead, caustic, lime, silica glass and/or other materials to facilitate the continuous feed of a smelting crucible. For this example the fluid materials are powders defined to be −800 to −900 mesh fine which are to be transported by a suction (vacuum) air stream of 28 inches of mercury. A 200 cubic foot per minute (CFM) air stream regulated at the intake is used, of which 10% by volume will be composed of the crushed (powdered) ore fines material. Constructing an inline mixer for these conditions requires looking at and understanding the fluid dynamics of the particular application consistent with the intended results. Material specifications for this application include but are not limited to PVC, ABS, iron, and Stainless Steel. In this preferred embodiment example, plates are inserted in the flow stream as discussed above. That is, the plates cause a directional change of flow as well as a restriction. As the fluid passes the plate restriction, the flow rate increases. As the fluid enters the following unrestricted area the flow rate decreases and a pressure drop occurs. This process is repeated throughout the length of the mixing device. As before the plates are set at an inclination consistent with the direction of flow while causing turbulence which cleans by purging the area just behind the plates. The particular parameters involved with this specific design are selected heuristically to not overly restrict the flow rate. The distance between the plates becomes important. Plates set too close cause too large of a restriction while plates set too far apart allow low pressure void areas behind the plates to remain virtually static allowing material to accumulate in the voids. For a 200 CFM flow rate it has been found that an acceptable blend is provided by an in-line pipe mixing device using an 8″ diameter pipe. With reference to FIG. 7, the first plate 72 is then inserted at an angle 74 of 60 degrees from the perpendicular. The plate extends 76 past the center axis of the pipe by ¼″.

FIG. 8 shows the plate 72 and the second plate 78 is then inserted at an angle of 60 degrees from the perpendicular on the opposite side of the pipe so that the two plates overlap with respect to the center axis by ¼″ each. The third plate 82 is then inserted at an angle of 60 degrees from the perpendicular on the same side of the pipe as the first plate so that it extends ¼″ past the center axis. Plates 72 and 82 are 17½ inches apart. The fourth plate 84 and the fifth plate 86 are identical to and set parallel to plates 72 and 78, respectively, but the spacing is increased to 18″. The spacing between plates 82 and 86 is 18″.

Plate 88 is positioned at an angle of 65 degrees from the perpendicular on the opposite side of the pipe from plate 86 and plate 88 extends ¼″ past the center axis of the pipe. The spacing between plates 86, 88 and between plates 88 and 90 is 9½″ so that the distance from plate 86 to plate 90 is 19″.

In another preferred embodiment, the plate may extend beyond the center axis by an inch or as much as 20% of the inner diameter of the pipe. In yet another preferred embodiment, the plates may extend from the inner surface of the pipe and a randomly distributed manner.

Succeeding plates are installed in the same manner as plates six and seven for the length of the mixing pipe. Injection ports are fabricated behind the plates, as discussed above, thereby utilizing the unrestricted area where a pressure drop occurs. In a particular application, ports behind plates one and two are supplied with a powdered material such as lime to provide a metered amount of 2.5% by volume of the total stream per port or 5% combined. Ports behind plates three and four are supplied with a powdered material such as lead to provide a metered amount consistent with 2.5% by volume of the total stream per port or 5% combined. Ports behind plates five and six are supplied with a powdered material such as caustic to provide a metered amount consistent with 2.5% by volume of the total stream per port or 5% combined. The three additives plus the initial powdered ore now comprise 25% of the total stream by volume in a 200 CFM air stream continuously supplying a crucible. A flow rate of 200 CFM of a device constructed in this manner translates to a flow velocity of about 19 feet per second in the mixing device In the above examples, and for other examples, the number of injector ports, different sized orifices of the injection ports, the number of plates, the angle of the plates, the separation of the plates, and the plates overlap on the center axis of the pipe may be determined on specific applications by trial and error.

In another preferred embodiment, the plated may be randomly arranged around the inner circumference of the pipe and only two of more plates may extend beyond the center axis of the pipe.

The above theoretical examples adapt variations of the basic design characteristics inherent to the inline mixing device to solve and/or expedite industry blending needs. The in-line mixer pipe may be of a wide variety of materials suited to the particular application, and the flow rates and pressure (or vacuum pressure differentials) drops and the physical dimensions of the mixer pipe may all be determined with respect to particular applications. Also, the number, angle, spacing and extension of the plates and the injection ports may all be determined from the particular applications.

What is claimed is:

1. An in-line fluid mixer comprising:
a conduit defining a center axis, the conduit with an entrance, an exit and arranged for carrying a fluid flow,
at least one plate located along the inner surface of the conduit and inclined along the direction of flow, and
wherein the plate extends beyond the center axis of the pipe.

2. The in-line fluid mixer as defined in claim 1 further comprising a plurality of plates which are alternately located on opposite sides of the conduit, and wherein each plate extends beyond the center axis.

3. The in-line fluid mixer as defined in claim 1 further comprising at least one injection port extending through the conduit downstream from a plate.

4. The in-line fluid mixer as defined in claim 3 further comprising a manifold for introducing a material to the at least one injection port.

5. The in-line fluid mixer as defined in claim 1 wherein the conduit is a pipe.

6. An in-line fluid mixer comprising:
a pipe with an entrance and an exit arranged for carrying a fluid flow,
a plurality of plates that extend from the inner walls of the pipe, and wherein the plates are inclinded at an angle relative to the axis of flow, and wherein the each plate extends beyond the center axis of the pipe, and
a plurality of injection ports, each port extending through the pipe downstream from a plate, and
a manifold for introducing a material to the injection ports.

7. The in-line mixer as defined in claim 6 wherein the plates are arranged alternately attached to opposite sides of the pipe, and wherein the inclined angle of the plates ranges from about fifteen degrees to about seventy-five degrees relative to the axis of the pipe, and wherein the plates extend beyond the axis of the pipe in a range from about zero inches to about one inch.

8. The in-line mixer as defined in claim 6 wherein the plates extend beyond the center axis of the pipe by a range of about zero to about twenty percent of the diameter of the pipe.

9. The in-line mixer as defined in claim 6 wherein the plates extend from the inner surface of the pipe in a random pattern around the inner circumference of the pipe, and where the plates extend randomly into the fluid flow, but wherein at least two such plates extend beyond the center axis of the pipe.
